(19) United States
(12) Patent Application Publication
(10) Pub. No.: US 2015/0166937 A1
(43) Pub. Date: Jun. 18, 2015

(54) LAUNDRY DETERGENT COMPOSITION AND METHOD OF MAKING THEREOF

(71) Applicant: SHELL OIL COMPANY, Houston, TX (US)

(72) Inventors: Robert Hardy Ellison, Katy, TX (US); Elizabeth Elaine Endler, Katy, TX (US); Carol Jean Klem, Houston, TX (US); Abraham Robert De Kraker, Sugar Land, TX (US); Sharla Nance Papitto, Cypress, TX (US); Catherine Semien, Katy, TX (US); Paul Theodore Sharko, Houston, TX (US)

(21) Appl. No.: 14/402,327

(22) PCT Filed: May 24, 2013
(86) PCT No.: PCT/US2013/042582

§ 371 Date: Nov. 20, 2014

Related U.S. Application Data
(60) Provisional application No. 61/652,503, filed on May 29, 2012.

(51) Int. Cl. C11D 3/34; C11D 11/00; C11D 3/20

(52) U.S. Cl. CPC C11D 3/3409; C11D 3/2017; C11D 11/0017

(57) ABSTRACT

A mixture of sulfates is made by dimerizing one or more even numbered alpha olefins to produce one or more vinylidenes; hydroformylating the vinylidene(s) to produce a mixture of alcohols; and sulfating the mixture of alcohols to form alcohol sulfates. The sulfates are useful in laundry detergents and other surfactants.

### FIELD OF THE INVENTION

The invention relates to a process for making a mixture of alcohol sulfates. The invention also relates to a laundry detergent composition comprising the alcohol sulfates and a method of improving the biodegradation rate of laundry wastewater by using the alcohol sulfates.

### BACKGROUND

Long chain branched alcohol sulfates are well known to provide good detergency in low temperature laundry applications. Previously developed long-chain branched alcohol sulfates have branches randomly distributed along the chain. Branches along the molecular backbone enhance solubility at low temperatures but can retard biodegradation of the molecule in wastewater treatment systems. Slow biodegradation can limit the quantity of the long-chain branched alcohol that can be used currently in laundry detergent formulations.

U.S. Pat. No. 6,320,080 describes a process for dimerizing alpha-olefins to form branched chain feedstocks for detersive surfactants in a process similar to that claimed herein. The patent teaches the use of a range of alpha olefins from C₅ to C₁₀. This patent does not mention biodegradation of the detersive surfactants when used in laundry detergent compositions nor does it identify that specific alpha olefins must be used to enhance the rate of biodegradation.

It would be advantageous to produce a laundry detergent composition that degraded quickly in wastewater treatment systems. This invention provides such a laundry detergent composition and a method of making the alcohol sulfates that operate as surfactants in the detergent. These compounds exhibit the necessary detergency while degrading more quickly under defined testing conditions.

### SUMMARY OF THE INVENTION

The invention provides a process of making a mixture of sulfates comprising: dimerizing even numbered alpha olefins to produce vinylidenes, hydroformylating the vinylidenes to form alcohols and sulfating the alcohols to form alcohol sulfates.

The invention further provides a laundry detergent composition comprising the alcohol sulfates produced by this process.

The invention further provides a method for providing rapid biodegradation of laundry wastewater comprising using a laundry detergent composition comprising branched alkyl alcohol derivatives wherein at least 50% of the branching occurs on even numbered carbon atoms.

### DETAILED DESCRIPTION OF THE INVENTION

The present invention is a long-chain branched alcohol sulfate in which methyl branches are distributed mainly on even-numbered carbons near the middle of the chain. It is anticipated that branching in this configuration will produce surfactants having good low temperature detergency. It is surprising that this configuration also significantly improves the rate of biodegradation, resulting in a laundry detergent with superior environmental benefits. It is believed that this benefit ensues because branching on even-numbered carbons results in degradation products that are rapidly metabolized by microbial attack while branching on odd-numbered carbons results in degradation products that are slowly metabolized. Consequently the slowly metabolized degradation products accumulate and retard the overall rate of biodegradation.

The first step of the process is to dimerize even numbered alpha olefins to form vinylidenes. Even numbered alpha olefins are defined as any alpha olefin having an even number of carbon atoms. The even numbered alpha olefins may include any even numbered alpha olefin with from 4 to 16 carbon atoms. The even numbered alpha olefins preferably comprise even numbered alpha olefins with from 6 to 10 carbon atoms. More preferred even numbered alpha olefins have 6 or 8 carbon atoms.

The dimerization may be carried out with a single even numbered alpha olefin or a blend of even numbered alpha olefins. When a single even numbered alpha olefin is used, it is preferably a C6, C8 or C10 alpha olefin. When a blend of even numbered alpha olefins is used, any combination of even numbered alpha olefins may be used.

Characteristics of the final product such as solubility and detergency are typically impacted by the starting materials selected, so the use of some blends of even numbered alpha olefins will result in more preferred final products. Some examples of possible blends are C4 with C8; C4 with C10; C4 with C12; C4 with C14; C6 with C8; C6 with C10; C6 with C12; C6 with C14; C8 with C10; and C8 with C12. Further it is possible to envision a blend of more than two even numbered alpha olefins that could be used to produce suitable products.

The process will be described below in respect to using a single even numbered alpha olefin, C8, but this process applies equally to the other single even numbered alpha olefins and the blends of alpha olefins described above.

The first step of the process is to dimerize 1-octene to produce 2-hexyl-1-decene. The 2-hexyl-1-decene is a vinylidene olefin that may also be referred to as 7-methylene pentadecane. There are a number of processes for carrying out this dimerization; for example, the processes described in U.S. Pat. No. 4,658,078; U.S. Pat. No. 4,973,788; and U.S. Pat. No. 7,129,197, which are herein incorporated by reference. Dimerization using a metallocene catalyst results in a single vinylidene compound being formed. The product may be distilled, if desired, to remove unreacted monomer and any trimer or higher oligomers that may have formed or the product may be directly used in the next step.

The second step of the process is to hydroformylate the 2-hexyl-1-decene to produce an alcohol mixture comprising 8-methyl-hexadecanol, 10-methyl-hexadecanol and 3-hexyl-undecanol. These three compounds that are formed correspond to hydroformylation at any of the three terminal carbon atoms of the vinylidene. Other products may also be formed by the hydroformylation.

The hydroformylation process may be carried out by reaction of the vinylidene with carbon monoxide and hydrogen according to the Shell Hydroformylation process as described in detail in U.S. Pat. No. 3,420,898; U.S. Pat. No. 6,777,579; U.S. Pat. No. 6,960,695; and U.S. Pat. No. 7,329,783, the disclosures of which are incorporated by reference. The hydroformylation process may also be carried out as described in U.S. Pat. No. 3,952,068 which is incorporated herein by reference.

The hydroformylation process may be carried out by reaction of the vinylidene with carbon monoxide and hydrogen according to the Oxo process as described in detail in Kirk-Othmer Encyclopedia of Chemical Technology, 4^{th} Edition, Volume 1, pp. 903-8 (1991), Jacqueline I. Kroschwitz, Executive Editor, Wiley-Interscience, New York which is herein incorporated by reference. The most commonly used is the modified Oxo process using a phosphine, phosphate, arsine, or pyridine ligand modified cobalt or rhodium catalyst as described in U.S. Pat. Nos. 3,231,621; 3,239,566; 3,239,569; 3,239,570; 3,239,571; 3,420,898; 3,440,291; 3,448,158; 3,448,157; 3,496,203; 3,496,204; 3,501,515; and 3,527,818, the disclosures of which are incorporated herein by reference.

Hydroformylation is a term used in the art to denote the reaction of an olefin with CO and H₂ to produce an aldehyde/alcohol which has one more carbon atom than the reactant olefin. Frequently in the art the term hydroformylation is utilized to cover the aldehyde and the reduction to the alcohol step in total, i.e., hydroformylation refers to the production of alcohols from olefins via carbonylation and an aldehyde reduction process. As used herein, hydroformylation refers to the ultimate production of alcohols.

Hydroformylation adds one carbon plus an —OH group, randomly to any one of the terminal carbons in the feedstock. Thus roughly equal percentages of 8-methyl-hexadecanol, 10-methyl-hexadecanol and 3-hexyl-undecanol are produced. In addition, 10-20% of saturated hydrocarbon and alcohols that were hydroformylated on a carbon other than a terminal carbon are typically produced as byproducts.

The alcohol mixture may optionally be separated such that it contains different amounts of the 8-methyl-hexadecanol, the 10-methyl-hexadecanol, or the 3-hexyl-undecanol.

The third step of the process is to sulfate the alcohol mixture by contacting the alcohol mixture with SO₃. The most common process for this step involves contacting the alcohol with gaseous sulfur trioxide in the reaction zone of a falling film sulfator. One embodiment of this process is described in U.S. Pat. No. 6,222,077, which is herein incorporated by reference

In another embodiment, the alcohols may be derivatized in another manner and the alcohol derivatives used in a laundry detergent composition. For example, branched alkyl carboxylate derivatives, branched alkyl ethoxylate derivatives, or branched alkyl ethoxy sulfate derivatives may be prepared and used in laundry detergent compositions.

In still another embodiment the derivatized alcohols may be used in detergent compositions used for other than laundry applications. For example, a branched alcohol derivative could be used in dishwashing products, or general household or industrial cleaning products.

The 8-methyl-hexadecanol and the 10-methyl-hexadecanol have the methyl branches on even numbered carbon atoms in the alkyl chain, and it is believed that this contributes and is possibly a major factor in the rapid biodegradation.

Further the alcohol and alcohol sulfates formed using even numbered alpha olefins as starting materials will always have methyl branching on an even numbered position. As described above, this is believed to be at least part of the reason for the rapid biodegradation.

The alcohol sulfates may be used in any surfactant product, typically including detergents for cleaning. A preferred application of these alcohol sulfates is in laundry detergent. The laundry detergent compositions may include granular, bar-form and liquid laundry detergents and may comprise additional components known to one of ordinary skill in the art. The additional components may comprise detergency builders, enzymes, polymeric soil release agents, bleaching compositions comprising a bleaching agent and one or more bleach activators, polymeric dispersing agents, brighteners, dye transfer inhibiting agents, suds suppressors, chelating agents and the like.

### EXAMPLES

Initial experiments were carried out to measure the biodegradation rate of various detergent components. The test method was designed to be compatible with the US EPA Fate, Transport, and Transformation Test Guidelines OPPTS 835.3110 (Paragraph (q)). Such test methods are well known to those skilled in biodegradation testing.

In brief, a measured quantity of the test material is dispersed in a culture medium. A measured amount of inoculum of a mixed population of sewage sludge micro-organisms is added to the culture medium. The flask containing the inoculated culture medium is maintained at constant temperature and with constant gentle stirring. As the biodegradation proceeds, the micro-organisms convert oxygen to carbon dioxide. The carbon dioxide is absorbed in an alkali trap resulting in a drop of internal pressure in the flask. This pressure reduction is detected and triggers an apparatus that replaces the oxygen converted by the micro-organisms. The quantity of fresh oxygen generated is monitored continuously and the extent of biodegradation is calculated from those measurements. Cumulative biodegradation is reported hourly as a percentage of the total test material.

### Example 1

In this example, a biodegradation measurement was carried out using the C17 sulfate surfactants prepared according to the invention. The cumulative biodegradation extent is reported in FIG. 1.

### Example 2

This example was carried out in the same manner as Example 1, except that a different surfactant was used. The surfactant is a mixture of C16 and C17 sulfates that have random branching on even and odd numbered carbon atoms. The cumulative biodegradation extent is reported in FIG. 1.

These results show that over the course of 336 hours (14 days) approximately 57% of the surfactant of Example 1 biodegraded. In contrast only approximately 45% of the surfactant of Example 2 biodegraded in the same amount of time. It is clearly seen that the surfactant of Example 1 degrades significantly more quickly.

### Example 3

In this example, a measurement of detergency was carried out using the C17 sulfate surfactants tested in Example 1. In this measurement, 9 test cloths of either 100% cotton or a polyester/cotton blend were soiled with a mixture of dust and synthetic sebum. Each was individually marked and an optical brightness measurement of each was made.

An aqueous solution of the following composition was prepared:

| | | |
|---|---|---|
| 0.30 | g/l | Test surfactant |
| 0.30 | g/l | Nonionic surfactant, C12-15(EO)7 |
| 0.15 | g/l | Triethanolamine |
| 0.15 | g/l | Sodium Citrate |
| 150 | ppm | Ca/Mg water hardness |

The test cloths were washed in a controlled manner at 20° C., rinsed, and dried. Optical brightness measurements were repeated and the proportion of soil removed from each was calculated from the optical brightness measurements. Soil removal for the 9 test cloths was averaged and the average was reported in Table 2.

### Example 4

This example was carried out in the same manner as example 3, except that the surfactant in Example 2 was used as the test surfactant. Soil removal results are reported in Table 1.

TABLE 2

| | Example 3 | Example 4 |
|---|---|---|
| Soil removal from 100% cotton test | 42.4% | 42.2% |
| cloths | | |
| Soil removal from polyester/cotton | 70.7% | 70.6% |
| test cloths | | |

These results show that the detergency of the surfactant used in examples 1 and 3 is substantially similar to the detergency of the surfactant used in examples 2 and 4.

1. A process of making a mixture of sulfates comprising:
a. dimerizing one or more even numbered alpha olefins to produce one or more vinylidenes;
b. hydroformylating the vinylidene(s) to produce a mixture of alcohols; and
c. sulfating the mixture of alcohols to form alcohol sulfates.

2. The process of claim 1 wherein the even numbered alpha olefins comprise alpha olefins having from 4 to 16 carbon atoms.

3. The process of claim 1 wherein the even numbered alpha olefins comprise alpha olefins having from 6 to 10 carbon atoms.

4. The process of claim 1 wherein the even numbered alpha olefins comprise a mixture of C6 and C8 alpha olefins.

5. A process of making a mixture of sulfates comprising:
a. dimerizing 1-octene to produce 2-hexyl-1-decene;
b. hydroformylating the 2-hexyl-1-decene to produce an alcohol mixture consisting essentially of 8-methyl-hexadecanol, 10-methyl-hexadecanol and 3-hexyl-undecanol; and
c. sulfating the mixture of alcohols to produce 8-methyl-hexadecanol sulfate; 10-methyl-hexadecanol sulfate and 3-hexyl-undecanol sulfate.

6. A laundry detergent composition comprising the alcohol sulfates produced in claim 5.

7. The laundry detergent composition of claim 6 wherein sulfates with 16 and 18 carbon atoms are not present.

8. A composition consisting essentially of 8-methyl-hexadecanol, 10-methyl-hexadecanol and 3-hexyl-undecanol.

9. The composition of claim 8 wherein the combination of 8-methyl-hexadecanol and 10-methyl-hexadecanol is at least 50 wt % of the total composition.

10. The composition of claim 8 wherein the combination of 8-methyl-hexadecanol and 10-methyl-hexadecanol is at least 70 wt % of the total composition.

11. The composition of claim 8 wherein the combination of 8-methyl-hexadecanol and 10-methyl-hexadecanol is at least 80 wt % of the total composition.

12. A method of improving the rate of biodegradation of laundry wastewater comprising using a laundry detergent composition comprising branched alkyl alcohol derivatives wherein at least 50% of the branching occurs on even numbered carbon atoms.

13. The method of claim 12 wherein at least 80% of the branching occurs on even numbered carbon atoms.

14. The method of claim 12 wherein the laundry detergent composition does not comprise any alcohol derivatives that have more than or less than 17 carbon atoms.
